(19) United States
(12) Patent Application Publication
(10) Pub. No.: US 2011/0112689 A1
(43) Pub. Date: May 12, 2011

(54) EGRESS LATCH

(75) Inventors: Alexander Thomas Riegelman, Berkley, MI (US); Michael Joseph Levy, Berkley, MI (US)

(73) Assignee: GM GLOBAL TECHNOLOGY OPERATIONS, INC., Detroit, MI (US)

(21) Appl. No.: 12/613,657

(22) Filed: Nov. 6, 2009

(51) Int. Cl. G05B 15/02; B60J 5/04

(52) U.S. Cl. 700/275; 49/502; 296/187.01

(57) ABSTRACT

A door for an entryway in a vehicle is provided. The door includes a latch mechanism configured to be fastened, such that the door maintains closure of the entryway, and capable of being activated and released, such that the door opens the entryway. The door also includes an interior-facing surface and an exterior-facing surface. The door additionally includes a control-surface portion operatively connected to, and incorporated into the interior-facing surface. The control-surface portion is moveable relative to the interior-facing surface, such that the moving of the control-surface portion relative to the interior-facing surface activates and releases the latch.

### TECHNICAL FIELD

The invention relates to access doors, and, in particular, to an egress latch for such a door.

### BACKGROUND OF THE INVENTION

A typical automobile has at least one access door. Such a door typically has a latch mechanism for maintaining the door in a locked state until access into or egress from the vehicle is required. The latch mechanism is typically actuated by an outside door handle to gain access to the interior of the vehicle, and by an interior door handle to facilitate exit from same. The interior door handle is typically incorporated into the door panel trim, and is positioned such that the handle may be easily reached and operated by an individual having regular or average dexterity.

### SUMMARY OF THE INVENTION

A door is provided for an entryway of a vehicle which includes a controller. The door includes a latch mechanism configured to be fastened, such that the door maintains closure of the entryway. The latch mechanism is capable of being activated and released, such that the door opens the entryway. The door also includes an interior-facing surface and an exterior-facing surface. The door additionally includes a control-surface portion operatively connected to, and incorporated into the interior-facing surface. The control-surface portion is moveable relative to the interior-facing surface, such that the moving of the control-surface portion relative to the interior-facing surface activates and releases the latch.

The door may also include a control switch operatively connected to the control-surface portion, wherein the control switch is configured to release the latch. An interlock feature may be additionally included to permit the control switch to release the latch solely when the vehicle is stationary. In such a case, an auxiliary switch may also be employed to override the interlock feature and permit the latch mechanism to be released when the vehicle is in motion. The auxiliary switch may be controlled via a button positioned on the interior-facing surface.

The controller may have an algorithm adapted for regulating the operation of the latch mechanism, the control switch, the interlock feature, and the auxiliary switch.

The control-surface portion may be configured such that it is moveable by being pushed toward the exterior-facing surface. The interior-facing surface and the control-surface portion may each be configured from a plastic material, and the control-surface portion may be operatively connected to the interior-facing surface via a living hinge.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a top view of a vehicle interior illustrating a door having an interior-facing surface with an integrated control-surface portion; and

FIG. 2 is a partial perspective view of the vehicle interior shown in FIG. 1.

### DESCRIPTION OF THE PREFERRED EMBODIMENTS

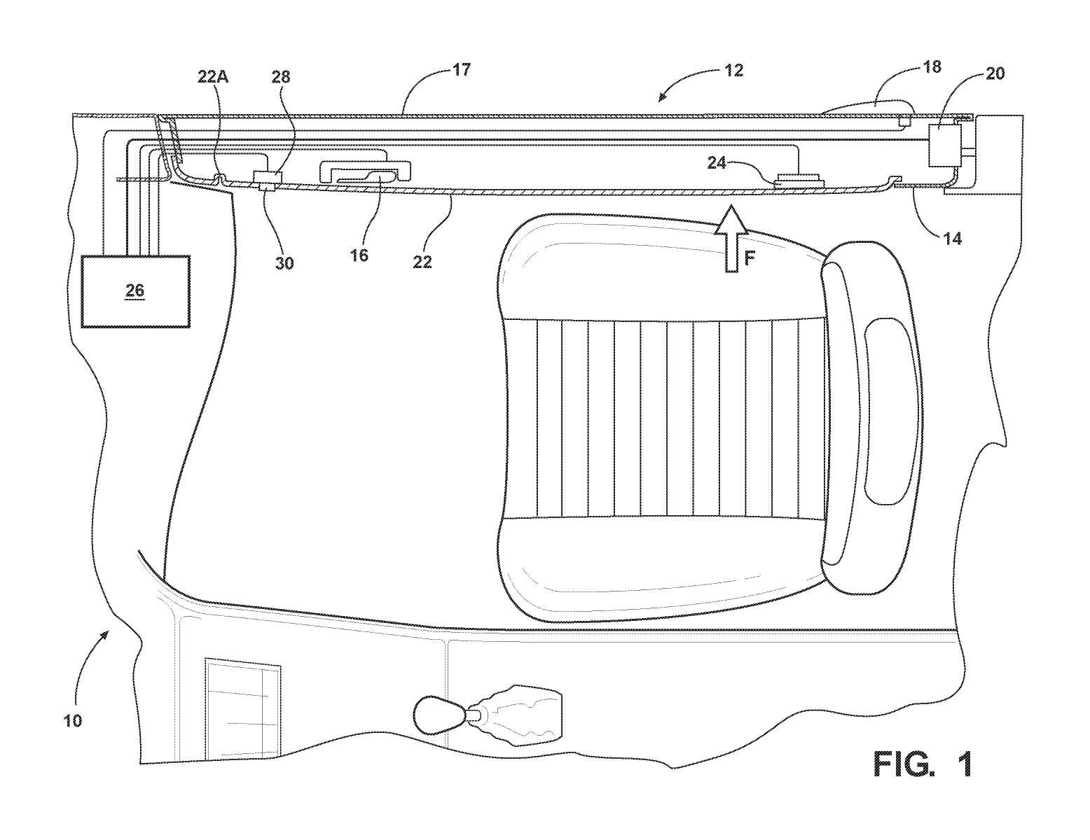

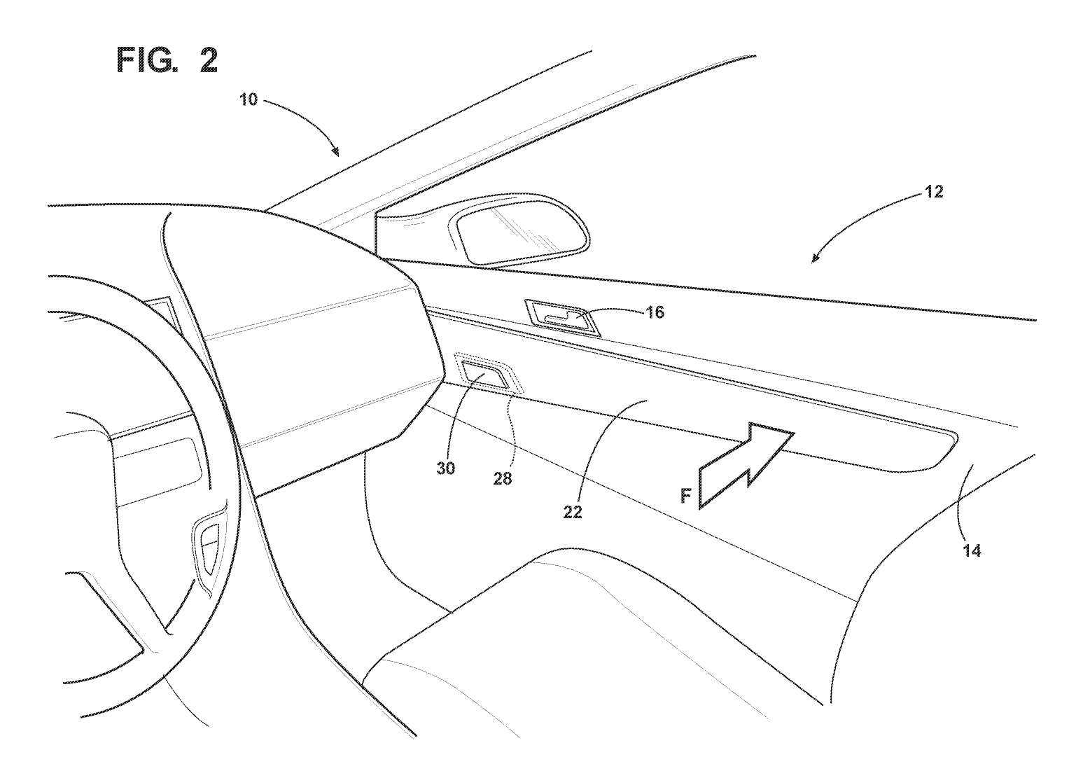

Referring to the drawings, wherein like reference numbers refer to like components, FIGS. 1 and 2 show a vehicle interior 10. The interior 10 includes a door 12 having an interior-facing surface 14. Interior-facing surface 14 includes an interior door-release handle 16. The door 12 also includes an exterior-facing surface 17. Exterior-facing surface 17 includes an exterior door-release handle 18. Furthermore, door 12 includes a latch mechanism 20 of the type known to those skilled in the art. The latch mechanism 20 is configured to be released via interior door-release handle 16, as well as via exterior door-release handle 18.

The interior-facing surface 14 also includes an integrated control-surface portion 22. The control-surface portion 22 is operatively connected to the interior-facing surface 14, and is configured to be moveable relative to the interior-facing surface. The control-surface portion 22 is an interior trim piece shaped as an aesthetically pleasing, functional part of the interior-facing surface 14 (as shown in FIG. 2). The control-surface portion 22 is configured to release latch mechanism 20 for egress from the vehicle. The control-surface portion 22 is configured to be activated via a natural, gross movement by an occupant of the vehicle, i.e., by pushing on the control-surface portion in the direction of exterior-facing surface 16 with a force F.

By design, the control-surface portion 22 is positioned such that it may be easily and conveniently accessed by the occupant of the vehicle. Such accessibility is particularly useful to individuals having age-related physical handicaps, such as arthritis, which may cause deterioration or loss of fine motor skills necessary to activate the interior door-release handle 16. A control switch 24 is concealed under the control-surface portion 22, and is operatively connected to the control-surface portion. Control switch 24 is configured to unlock the door 12 by releasing the latch mechanism 20, preferably by being activated via control-surface portion 22, when the control-surface portion is subjected to force F.

Control-surface portion 22 is joined to the interior-facing surface 14 via a living-hinge 22A (shown in FIG. 1). As understood by those skilled in the art, a living-hinge is a thin flexible hinge that joins together two relatively rigid plastic parts. A living-hinge is molded simultaneously with the two other parts as a single unitary piece, permitting those two parts to bend relative to each other along the line of the hinge. In the present embodiment, the control-surface portion 22 and the interior-facing surface 14 are each configured from a moldable plastic material, as understood by those skilled in the art.

The control-surface portion 22 and the interior-facing surface 14 are operatively connected by the living-hinge 22A, and the control-surface is structurally incorporated and fits into the interior-facing surface portion. The living-hinge 22A joins the control-surface portion 22 to the interior-facing surface 14, thus forming a single, unitary panel, while permitting the control-surface portion to bend relative to the interior-facing surface for actuating control switch 24. The control-surface portion 22 and the interior-facing surface 14 are also aesthetically integrated to create the appearance of a unitary door panel.

As shown in FIG. 1, a controller 26 is positioned relative to the vehicle interior 10. Controller 26 is programmed with an algorithm for regulating the operation of the latch mechanism 20, and the control switch 24. Controller 26 is additionally programmed with an algorithm that includes an interlock feature that permits the control switch 24 to release the latch 20 solely when the vehicle is in stationary. As shown in FIG. 1, an auxiliary switch 28 is positioned on the door 12. Auxiliary switch 28 is configured as a secondary door release device for overriding the interlock feature in order to permit the latch mechanism 20 to be released when the vehicle is in motion.

Auxiliary switch 28 may be activated by a button 30. Button 30 is shown as being positioned on the interior-facing surface 14. Button 30 may be incorporated into the control-surface portion 22, or be located elsewhere on the interior-facing surface 14. Location of button 30 is preferably determined such that it may not be actuated by the occupant inadvertently. Although the auxiliary switch 28 is activated by button 30, the algorithm of controller 26 is programmed to regulate operation of the auxiliary switch 28 based on either sensed or calculated road speed of the vehicle.

While the best modes for carrying out the invention have been described in detail, those familiar with the art to which this invention relates will recognize various alternative designs and embodiments for practicing the invention within the scope of the appended claims.

1. A door for an entryway in a vehicle having a controller, the door comprising:
a latch mechanism configured to be fastened, such that the door maintains closure of the entryway, and capable of being activated and released, such that the door opens the entryway;
an interior-facing surface and an exterior-facing surface; and
a control-surface portion operatively connected to, and incorporated into the interior-facing surface, the control-surface portion being configured to move relative to the interior-facing surface, such that the moving of the control-surface portion relative to the interior-facing surface activates and releases the latch.

2. The door of claim 1, further comprising a control switch operatively connected to the control-surface portion, wherein the control switch is configured to release the latch mechanism.

3. The door of claim 2, further comprising an interlock feature configured to permit the control switch to release the latch mechanism solely when the vehicle is stationary.

4. The door of claim 3, further comprising an auxiliary switch configured to override the interlock feature and permit the latch mechanism to be released when the vehicle is in motion.

5. The door of claim 4, wherein the auxiliary switch is controlled via a button positioned on the interior-facing surface.

6. The door of claim 5, wherein the controller includes an algorithm adapted for regulating the operation of the latch mechanism, the control switch, the interlock feature, and the auxiliary switch.

7. The door of claim 1, wherein the control-surface portion is configured to be moveable by being pushed toward the exterior-facing surface.

8. The door of claim 1, wherein the interior-facing surface and the control-surface portion are each configured from a plastic material, and the control-surface portion is operatively connected to the interior-facing surface via a living hinge.

9. A vehicle having an entryway, the vehicle comprising:
a controller;
a door for the entryway;
a latch mechanism configured to be fastened, such that the door maintains closure of the entryway, and capable of being activated and released, such that the door opens the entryway;
an interior-facing surface and an exterior-facing surface; and
a control-surface portion operatively connected with the interior-facing surface, wherein the control-surface portion and the interior-facing surface form a unitary panel, and the control-surface portion is configured to move relative to the interior-facing surface, such that the moving of the control-surface portion relative to the interior-facing surface activates and releases the latch.

10. The vehicle of claim 9, further comprising a control switch operatively connected to the control-surface portion, wherein the control switch is configured to release the latch mechanism.

11. The vehicle of claim 10, further comprising an interlock feature configured to permit the control switch to release the latch mechanism solely when the vehicle is stationary.

12. The vehicle of claim 11, further comprising an auxiliary switch configured to override the interlock feature and permit the latch mechanism to be released when the vehicle is in motion.

13. The vehicle of claim 12, wherein the auxiliary switch is controlled via a button positioned on the interior-facing surface.

14. The vehicle of claim 13, wherein the controller includes an algorithm adapted for regulating the operation of the latch mechanism, the control switch, the interlock feature, and the auxiliary switch.

15. The vehicle of claim 9 wherein the control-surface portion is configured such that it is moveable by being pushed toward the exterior-facing surface.

16. The vehicle of claim 9, wherein the interior-facing surface and the control-surface portion are each configured from a plastic material, and the control-surface portion is operatively connected to the interior-facing surface via a living hinge.

17. A vehicle having an entryway, the vehicle comprising:
a door for the entryway;
a latch mechanism configured to be fastened, such that the door maintains closure of the entryway, and capable of being activated and released, such that the door opens the entryway;
an interior-facing surface and an exterior-facing surface;
a control-surface portion operatively connected to, and incorporated into the interior-facing surface, the control-surface portion configured to be moveable relative to the interior-facing surface, such that the moving of the control-surface portion relative to the interior-facing surface activates and releases the latch;
a control switch operatively connected to the control-surface portion, wherein the control switch is configured to release the latch mechanism;
an interlock feature configured to permit the control switch to release the latch solely when the vehicle is stationary;
an auxiliary switch configured to override the interlock feature and permit the latch mechanism to be released when the vehicle is in motion; and
a controller having an algorithm adapted for regulating the operation of the latch mechanism, the control switch, the interlock feature, and the auxiliary switch.

18. The vehicle of claim 17, wherein the auxiliary switch is controlled via a button positioned on the interior-facing surface.

19. The vehicle of claim 17, wherein the control-surface portion is configured such that it is moveable by being pushed toward the exterior-facing surface.

20. The vehicle of claim 17, wherein the interior-facing surface and the control-surface portion are each configured from a plastic material, and the control-surface portion is operatively connected to the interior-facing surface via a living hinge.
